(19) United States
(12) Patent Application Publication
(10) Pub. No.: US 2017/0346381 A1
(43) Pub. Date: Nov. 30, 2017

(54) AT WILL 7 POWER Fuelless Generator

(71) Applicant: Donti Peets, Alexandria, VA (US)

(72) Inventor: Donti Peets, Alexandria, VA (US)

(21) Appl. No.: 15/163,970

(22) Filed: May 25, 2016

(51) Int. Cl. H02K 47/00; H02K 7/10; H02K 9/04; H02K 53/00

(52) U.S. Cl. CPC H02K 47/00; H02K 9/04; H02K 7/1004; Y10S 74/09; H02K 53/00

(57) ABSTRACT

The AT WILL 7 POWER Fuelless Generator operates starting with a small or large rechargeable 12 v battery or batteries, dc to ac inverter or inverters, or ac to dc converter or converters, or dc to ac inverter and ac to dc converter or nether dc to ac inverter or ac to dc converter, dc electric motor, a/c or d/c electric motor or motors, alternator or alternators, generator head or generator heads, tapered cone generator or tapered cone generators, generator or generators; 12 volt radiator fan or radiator fans, belt and pulley system, tension pulley or tension pulleys or nether, and a few other components to make it a high efficiency long lasting fuelless electric generator. The noise level on this generator is very low and the weight is lighter then most generators on the market right now. Because of it's zero pollution it can operate indoors continuously with out generating a lot of heat. This is a stand alone system and has no support from wind, or sun. This generator comes in different sizes, voltages and watts for homes and commercial use.

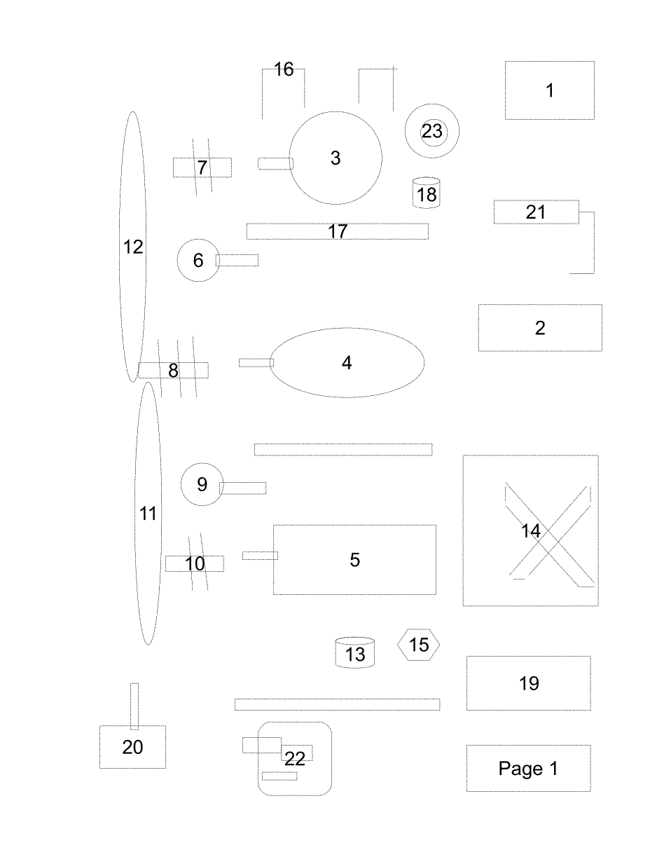

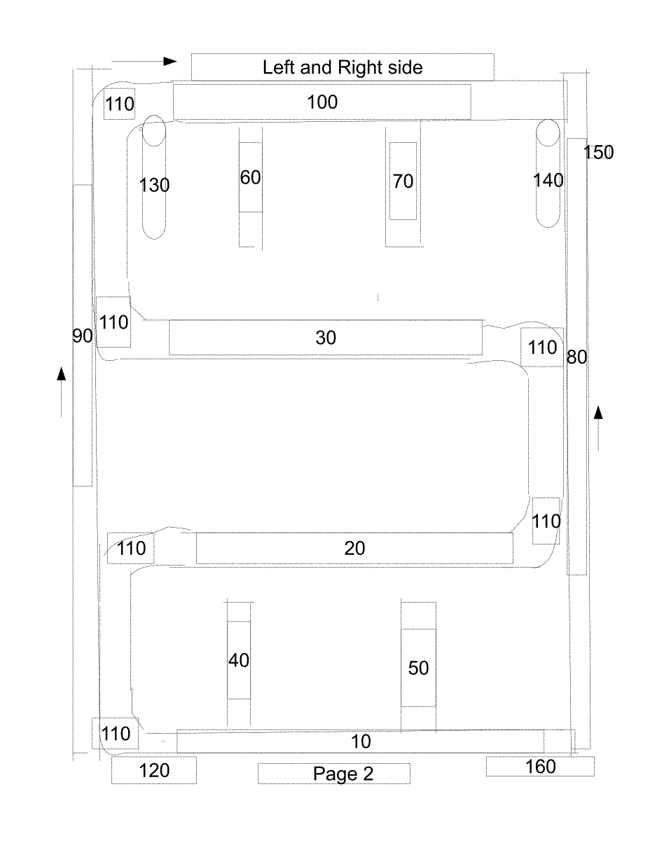

### BACKGROUND OF INVENTION

### 1. Field of the Invention

This machine is a dependable and affordable self powered fuelless generator that is great for the environment because it doesn't use any fuel or motor oil of any kind, that means zero pollution. This machine will help preserve the environment in so many ways because theirs no fumes unlike some of the gas and diesel generators on the market now.

### 2. Background

This is a system that combines the use of a switch, battery, dc to ac inverter or ac to dc converter or both, a/c or d/c electric motor, alternator and a generator spinning at 3600 rpm or more using a belt and pulley system to generate enough energy to power a house or a commercial building

### SUMMARY OF THE INVENTION

This present invention is to supply power to any one any where except under water without the use of gas, diesel fuel, sun or wind. This stand alone system will operate none stop on one source of energy once it's turned on and that is it's self. This continuously running machine is built to last with no major issues.

With a built in fan, it is a good way to keep the system cool and from operating at high temperatures when it's continuously running at high rpm.

### Advantages

This system is not as heavy as the other generators because it does not consume any fuel, oil or an engine and it doesn't have a fuel tank, So moving it when it's operating or when it's not shouldn't be a problem.

This invention also has a backup just in case the battery fails to work and that is the 700 to 2000 watt, 60 to 240 volt d/c to a/c inverter and it is wired with a cigarette lighter inlet plug on the other end to plug in side a car or trucks cigarette lighter to jump start it when the power goes down and a 2 or 3 prong 120 volt inlet plug to plug in a wall outlet to also jump it when the power goes down.

The noise level on this generator is very low and the weight is lighter then most generators on the market right now. Because of it's zero pollution it can operate indoors continuously with out generating a lot of heat.

### BRIEF DESCRIPTION OF THE DRAWINGS

Without restricting the full view of this invention, the invention is illustrated in the drawings:

Page. 1 of the drawings has the best display of the embodiment of the invention.

Page. 2 of the frame drawings has the best display of the frame embodiment of the invention.

### BRIEF DESCRIPTION OF THE PREFERRED EMBODIMENTS

It Works, as Shown on Page.1.

When the switch 20 is turned on, that allows the power from the 12 volt battery 1 to flow to the d/c to a/c inverter 2. Then when switching on the d/c to a/c inverter 2 allows it to receive the power from the 12 volt battery 1. Now the d/c to a/c inverted 2 is powered and ready to give power. A plug 22 is plunged in the outlet of the d/c to a/c inverter 2 and on the other end of that plug 22 is a 60 to 120 volt voltage speed regulator 19 that will control the voltage going in and control the speed the a/c electric motor 4 puts out with a wire connection. With the double pulley 8 attached to the shaft of the a/c electric motor 4, and the pulley 10 attached to the shaft of the generator 5 with a belt 11 and the belt tension 9 in between, and the pulley 7 attached to the shaft of the alternator 3 with a belt 12 and the belt tension 6 in between will allow all objects to rotate once the power is feed to the a/c electric motor 4.

Once the power is feed to the a/c electric motor 4 and the rotating begins, the alternator 3 will start giving a 12 to 14 v charge to the 12 volt battery 1 keeping the 12 volt battery 1 charged so it can it turn power the d/c to a/c inverter 2 with the 12 volts that is needed so the d/c to a/c inverter 2 can in turn power the a/c electric motor 4, doing this continuously until switch 20 is shut off.

Once the d/c to a/c electric motor 4 is powered and rotating at 3600 rpm the generator 5 will be putting out the max output of watts and voltage for the main power with no loss of power. To keep the system cool a fan 14 is used with a on and off switch 20 to blow air on the system during operation with a wire to the 12 volt battery 1.

U bolt clamps 16, bolts, lock nuts 15, washers 23 and rubber shocks 18 are used to hold the alternator 3 down to a metal plate 17 and reduce the vibration. The d/c to a/c electric motor 4 and the generator 5 also have bolts, lock nuts 15, washers 23 and rubber shocks 13 to hold it down to a metal plate 17 and reduce the vibration when operating.

A cigarette lighter inlet plug 21 is also attached to the d/c to a/c inverter 2 on the side where the 12 volt battery is attached to and the inlet side of the plug can be plugged in to a car or trucks cigarette lighter outlet in case the 12 volt battery 1 fails to work and also there is a inlet plug 22 for a wall outlet that is wired to the voltage speed regulator 19 in case the 12 volt battery fails to work.

The Embodiment of the Frame on Page 2.

The frame has two sides, a left side and a right side, the diagram that is shown only shows one side but what you see will be on both sides, two individual sides with 4 square, or circle, or cylinder, or rectangle metal tubes or pipe 40,50,60, and 70 separating the two with a width of 5 to 50 inches. In between the two frames there is also 3 metal plates 17 that is on page 1 that will be apart of the frame and will be used as three sections 10, 20 and 30, section 10 will be the generator, section 20 will be the electric motor, section 30 will be the alternator and 100 will be the top of the frame.

The length of the frame from front 80 to back 90 is between 5 to 50 inches.

The frame will be made of square, or circle, or cylinder or rectangle metal tubes or pipe that will have 12 corners 110 that will have a 90 degree bend in the shape of the letter “S” with 2 support square, or circle, or cylinder or rectangle metal tubes or pipe welded to the front 80 and to the back 90 on the left side and the other two will be welded on the front and back of right side of the “S” shaped frame. [0021]

The height of the frame will be between 5 to 50 inches.

The top front 140 and back 130 will use a circle, or cylinder shaped tube or pipe to be used as grab a handle to pickup and move and the front 150 also has a grab handle to pick only the front up and move using the rear non rotating or rotating wheels 120 with front rubber 160 stand.

1. A fuel less electric powered generator system comprising: Starting with a small or large rechargeable 12 v battery or batteries, dc to ac inverter or inverters, or ac to dc converter or converters, or dc to ac inverter and ac to dc converter or nether dc to ac inverter or ac to dc converter, a/c or d/c electric motor or motors, alternator or alternators, generator head or generator heads, tapered cone generator or tapered cone generators, generator or generators, radiator fan or radiator fans, belt and pulley system, tension pulley or tension pulleys or nether, a rpm gauge, a voltage gauge for battery, a voltage gauge for generator, a front panel light, a on and off switch, a 120 volt inlet plug, a cigarette lighter inlet plug, u bolts clamps, lock nuts, rubber shocks, screws and washers, metal plate, and voltage speed regulator.
The basic break down on how it works is a 12 v battery or batteries are wired to a 700 to 2000 w, 60 to 240 v d/c to a/c inverter or inverters on the d/c connection side and then wired to a voltage speed regulator to control the speed with a inlet plug from the voltage speed regulator plugged in to the inverters outlet to power the a/c electric motor or motors allowing it to spin the pulley and belt that is attached to it and attached to the alternator or alternators, generator head or generator heads, generator or generators, and or tapered cone generator or tapered cone generators.
When the alternator is spinning it will create 12 to 14 volts d/c power to keep the battery or batteries charged to in turn power the inverter so it can power the a/c electric motor or motors so it can spin at 3600 rpm or more, and recharge the battery or batteries and power a fan or fans to keep things cool during operation with a wire connection.
While the generator or generators are spinning at 3600 rpm it will give you maximum wattage and voltage witch will be anywhere from 1000 to 15000 watts and 60 to 240 volts or more with no power loss, The power for use will be the power coming from the generator head or generator heads, tapered cone generator or tapered cone generators, and or generator or generators it's self.
To keep the system cool a fan is used with a on and off switch to blow air on the system during operation with a wire to the 12 volt battery.
U bolt clamps, bolts, lock nuts, washers and rubber shocks are used to hold the alternator down to a metal plate and reduce the vibration. The d/c to a/c electric motor and the generator also have bolts, lock nuts, washers and rubber shocks to hold it down to a metal plate and reduce the vibration when operating.
A cigarette lighter inlet plug is also attached to the d/c to a/c inverter on the side where the 12 volt battery is attached to and the inlet side of the plug can be plugged in to a car or trucks cigarette lighter outlet in case the 12 volt battery fails to work and also there is a inlet plug for a wall outlet that is wired to the voltage speed regulator in case the 12 volt battery fails to work.

2. When a 12 volt d/c electric motor or motors is used instead of the a/c electric motor or motors the d/c to a/c inverter is not needed in this case, the battery or batteries will power the d/c electric motor or motors to begin the spinning rotation and once that happens the alternator will begin charging the battery or batteries so that the battery or batteries can continuously power the dc electric motor or motors, with a voltage speed regulator in between the battery or batteries and the d/c electric motor.
Another way is the battery or batteries can be wired to a d/c to a/c inverter and then wired to the a/c to die converter and then wired to a voltage speed regulator to control the speed and then wired to the die electric motor and once the spinning rotation begins the alternator will keep the battery or batteries charged and the battery or batteries will continuously power the d/c to a/c inverter witch in turn powers the a/c to d/c converter and then powers the d/c electric motor to spin at 3600 rpm.
